(19) United States
(12) Patent Application Publication
(10) Pub. No.: US 2002/0000239 A1
(43) Pub. Date: Jan. 3, 2002

(54) REMOVAL OF CURED SILICONE ADHESIVE FOR REWORKING ELECTRONIC COMPONENTS

(76) Inventors: KRISHNA G. SACHDEV, HOPEWELL JUNCTION, NY (US); UMAR M. AHMAD, HOPEWELL JUNCTION, NY (US); FAREED Y. AUDI, WEST LAFAYETTE, IN (US); DANIEL G. BERGER, WAPPINGERS FALLS, NY (US); JOHN U. KNICKERBOCKER, HOPEWELL JUNCTION, NY (US); CHON C. LEI, POUGHKEEPSIE, NY (US)

Correspondence Address: DELIO & PETERSON, 121 WHITNEY AVENUE, NEW HAVEN, CT, 06510

(21) Appl. No.: 09/406,645

(22) Filed: Sep. 27, 1999

(51) Int. Cl. B08B 9/00; C11D 1/00; C09D 9/00; C23G 1/00

(52) U.S. Cl. 134/2; 134/22.17; 134/22.19; 134/34; 134/36; 134/40; 134/42; 510/201; 510/202; 510/212; 510/504; 510/238; 510/259; 510/407; 510/432

(57) ABSTRACT

A stripping composition and a method of using the stripping composition to remove cured resins such as elastomeric silicone adhesive deposits from ceramic and metal surfaces of electronic modules to provide reworkability options in assembly processes including diagnostic parts, parts replacement and recovery of substrates from test vehicles is provided. The stripping compositions comprise a base preferably an organic base such as a quaternary ammonium hydroxide, a surfactant and a high boiling environmentally and chemically safe solvent such as di- or tri-propylene glycol alkyl ether. In another stripping composition, the base is used in combination with a mixture of N-alkyl pyrrolidone components, preferably an N-alkyl pyrrolidone and a N-cycloalkyl pyrrolidone. The stripping compositions are used to contact an electronic module having a cured resin such as a silicone adhesive residue deposit on the module surface to dissolve, remove or strip the deposit.

### BACKGROUND OF THE INVENTION

1. Field of the Invention

The present invention relates generally to an improved stripping composition and method of removing cured resins such as elastomeric silicone adhesive deposits from ceramic and metal surfaces of electronic modules to provide reworkability options in assembly processes including diagnostic tests, parts replacement and recovery of substrates from test vehicles and, in particular, to the removal of cured Sylgard™ silicone adhesive polymer residue from seal band in non-hermetic electronic packages where the adhesive is used to attach a metal cap to a substrate for protection against mechanical damage, moisture ingress and corrosion from exposure to the environment.

2. Description of Related Art

Microelectronics fabrication processes often require disassembly of assembled components, for example, to carry out diagnostic tests, to replace or repair the semiconductor device, or to recover electrically good substrates from test vehicles or early user hardware used to assess product performance and reliability prior to actual product release. Removal processes for various assembly materials must be selective for a particular material and cause no detriment to the substrate integrity and electrical performance. It is also required that the removal method be environmentally and chemically suitable for use in a manufacturing environment.

In one application, silicone polymers are used as an adhesive to attach a metal protective cap to a ceramic substrate of a semiconductor device for protection against mechanical damage, moisture ingress and environmental corrosion. Other applications for the silicone polymers include: device encapsulation, top seal between the chip and the substrate to provide α-particle barrier, circuit board coating, and conductive silicones to attach a heat spreader to the backside of a flip chip for heat dissipation. Thermally and electrically conductive formulations based on a silicone matrix and various types of fillers such as silica, alumina, aluminum nitride, metals as Ni, Cu, Ag, Au, silver plated Al, In—Sn and carbon black find applications as adhesives for direct attachment of a device chip to a substrate, and heat sink or heat slug attachment for heat dissipation and as die bond adhesive in wire bonded packages. Commonly used heat slug materials include Al—SiC, metal matrix composite, Cu, and Mo.

Sylgard™ and related silicone elastomers are based on poly-(organosiloxane) curing chemistry involving cross-linking reaction of vinyl-terminated-poly(dimethylsiloxane) and dihydro-dimethyl polysiloxane in the presence of a catalyst. Sylgard™, made by Dow Corning Corp., is a primerless organosiloxane based two component system comprising as part A a vinyl-functionalized (CH2═CH—) siloxane, typically vinyl-terminated-poly(dimethylsiloxane) and curing catalyst and part B which contains vinyl terminated poly(dimethylsiloxane) and the crosslinker methyl-hydrosiloxane dimethyl siloxane copolymer. The adhesive composition is typically prepared by mixing equal parts of the two components and the mix is deaerated to remove any trapped bubbles. The adhesive is applied onto the surfaces to be bonded and the parts are assembled and cured at about 170-175° C. for about 45-60 min. FIG. 1 below is an illustration of the Sylgard™ chemistry in terms of the reactive components and the curing reactions involved. The crosslinking reactions between the precursors are heat-accelerated resulting in a cured hydrophobic polymer of flexible/elastomeric matrix having special stress absorbing properties. These characteristic features of elastomeric silicones are particularly useful for providing protection from moisture ingress and maintenance of an adhesive joint between materials having different thermal coefficient of expansion (TCE) under high stress conditions during thermal cycling and other reliability stress test exposures. The following silicone structure and resulting polymer is typical:

FIG. 1

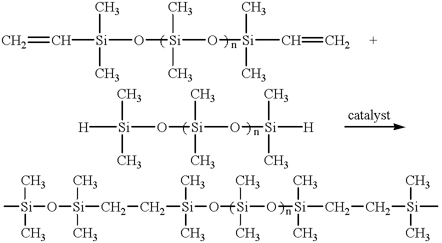

Thermally and electrically conductive silicones are obtained by incorporating conductive fillers such as alumina, silica, aluminum nitride, and metal powders or carbon black for electrical conductivity when necessary. Typically, the adhesive formulation comprises Al₂O₃ and SiO₂ filled polydimethyl siloxane/dimethyl vinyl terminated glycidoxypropyl trimethoxy silane and dimethyl methyl hydrogen siloxane components and a curing catalyst. Electrically conductive silicone and fluorosilicone resins for bonding chips to lead frames may contain metal powder or metal coated inorganic or organic polymer particles.

A major problem with crosslinked elastomeric silicones such as Sylgard™ is the lack of a satisfactory method for removing such coatings to provide residue-free substrate surfaces when it is required to repair or replace defective components or to reclaim selected parts of a module assembly. Methods based on mechanical removal by scrapping-off the silicone adhesive/encapsulant that are commonly known are not satisfactory due to incomplete removal and surface damage caused in the process. Also, the mechanical methods invariably require additional cleaning operations using organic solvents for complete removal.

U.S. Pat. No. 3,969,813 issued to Minetti et al. describes a high pressure water jet technique to remove RTV (room temperature vulcanization) silicone encapsulant under the chip to lift-off the chip by mechanical impact of a directed high pressure H₂O jet stream at 12,000 to 20,000 psi pressure. This method, however, leaves silicon residue which is removed by subsequent solvent-based cleaning with isopropanol, a highly flammable solvent.

U.S. Pat. No. 3,673,099 issued to W. J. Corby describes a method for stripping cured silicones and vinyl polymers such as polyvinyl cinnamates from substrates using an organic or inorganic base in N-methyl-2-pyrrolidone (NMP) with or without another solvent. Specific stripping compositions claimed to be effective for removing methyl-phenyl polysiloxane resins comprise guanidine carbonate or quaternary ammonium hydroxide in NMP and ethylene glycol monomethyl ether.

U.S. Pat. No. 3,947,952 issued to Miller et al. describes a method of encapsulating beam lead semiconductor devices by a multi-step process including a step involving selective removal of an unmasked portion of a silicone resin through a resist mask. The disclosed stripping compositions are comprised of a tetramethyl ammonium hydroxide (TMAH) in 1:2 volume ratio of NMP and isopropanol for removing exposed silicone resin after which the resist mask is removed exposing the remaining silicone resin film protection over active areas of the device.

U.S. Pat. No. 4,089,704 issued to J. H. Heiss et al. describes a method of removing silicone rubber encapsulating material from microelectronic circuits using methanolic TMAH and ethanol or isopropanol. Specific siloxane polymers are those with methoxy end groups which undergo curing reactions in air in the presence of moisture.

Cured organic silicones are also known to be removed by spray solutions containing a 1:1 ratio of methylene chloride and Freon with less than 10% of ethanol added.

The various solvent-based stripping compositions used in the references cited above are not practical for use in manufacturing environment because of the following problems:

a) Methanol, ethanol, and isopropanol are very low boiling point solvents with high flammability and thus have chemical safety issues for use in manufacturing applications. Also, these alcohols are classified as Volatile Organic Compounds (VOCs) which are subject to VOC regulations requiring strict control of air emissions by installing special control devices.

b) Use of ethylene glycol ether solvents as ethylene glycol monomethyl or diethyl ether has become highly restricted in industrial processes due to associated human toxicity. This category of solvents are on the TRI (toxic release inventory) list which are subject to strict environmental regulations for hazardous air pollutants (HAPs).

c) Chlorinated solvents such as methylene chloride are classified as HAPs and thus are under strict environmental regulations which has restricted their use in production processes in the recent years. The fluorochlorocarbons such as Freons are among the Ozone Depleting Solvents (ODS) which have been banned and their use has already been phased-out.

Bearing in mind the problems and deficiencies of the prior art, it is therefore an object of the present invention to provide a method of removal of cured resins such as silicone polymer from electronic components for rework or repair of defective components in assembled electronic modules.

It is another object of the present invention to provide a method of removal of cured resins such as silicone polymer which allows reclamation of expensive test vehicles (TVs) which are currently discarded for lack of a recovery process and thus adding to the overall cost of the product and increasing the waste volume to be disposed.

A further object of the invention is to provide a method for Sylgard™ silicone polymer removal from various surfaces of electronic modules which minimizes or eliminates environmental hazards, toxicity and flammability issues associated with the methods described in the prior art.

An additional object of the invention is to provide a stripping composition for dissolving, removing or stripping cured resins such as silicone polymers on electronic components and assembled electronic modules.

Still other objects and advantages of the invention will in part be obvious and will in part be apparent from the specification.

### SUMMARY OF THE INVENTION

The above and other objects and advantages, which will be apparent to one of skill in the art, are achieved in the present invention which is directed to, in a first aspect, a method for removing cured resins such as silicone adhesive deposits from ceramic and metal surfaces of electronic modules comprising the steps of:

supplying a ceramic or metal electronic module having a silicone adhesive residue deposit on the module surface;

contacting the module with a stripping composition comprising a base preferably an organic base such as a quaternary ammonium hydroxide including aliphatic quaternary ammonium hydroxides such as tetraalkyl ammonium hydroxide, and a surfactant, preferably a non-ionic surfactant, and a compatible non-hazardous high boiling organic solvent having a flash point over about 60-65° C. such as di- or tri-propylene glycol alkyl ether and related Dowanol glycol ether solvents sold by Dow Chemical Co., the contacting being performed at a temperature of about room temperature to about 110°-120° C. or higher for an effective time usually about 30 min. to 120 min. to degrade, dissolve, remove or strip the silicone polymer adhesive deposit on the substrate surface; and

rinsing the contacted substrate preferably with deionized water to remove the residual contacted and degraded silicone polymer and adhering stripping composition on the surface of the substrate.

In a further aspect of the invention, a method is provided for removing cured resins such as silicone polymer adhesive deposits from ceramic and metal surfaces of electronic modules comprising the steps of:

supplying a ceramic or metal electronic module having a silicone polymer adhesive deposit on the module surface;

contacting the electronic module with a stripping composition comprising a base, preferably an organic base such as a quaternary ammonium hydroxide including aliphatic quaternary ammonium hydroxides such as tetraalkyl ammonium hydroxide, and a mixture of alkyl and/or cycloalkyl pyrrolidones such as a mixture of N-methylpyrrolidone (NMP) and N-cyclohexylpyrrolidone (CHP), with or without a surfactant, the contacting being performed at a temperature of about room temperature to about 110°-120° C. or higher, preferably about 80°-100° C. for an effective time usually about 30 min. to 120 min. to degrade, dissolve, remove or strip the silicone polymer adhesive deposit on the electronic module surface; and

rinsing the contacted substrate preferably with deionized water to remove the residual contacted and degraded silicone polymer and adhering stripping composition on the surface of the substrate.

In another aspect of the invention, a stripping composition is provided for removing cured resins such as silicone polymer adhesive deposits from ceramic and metal surfaces of electronic modules comprising, by weight %:

a base, preferably an organic base such as a quaternary ammonium hydroxide including aliphatic quaternary ammonium hydroxides such as tetraalkyl ammonium hydroxide in an effective amount of about 0.5 to 5% based on anhydrous material;

a surfactant, preferably a non-ionic surfactant, in an amount of about 0.05 to 0.5%; and

a high boiling solvent, preferably having a flash point above about 60-65° C., and which is non-hazardous such as di- or tri-propylene glycol alkyl ether wherein the alkyl group is C1-C8, preferably C1-C4.

In a further aspect of the invention, a stripping composition is provided for removing silicone polymer adhesive deposits from ceramic and metal surfaces of electronic modules comprising, by weight %:

a base, preferably an organic base such as a quaternary ammonium hydroxide including aliphatic quaternary ammonium hydroxides such as tetraalkyl ammonium hydroxide in an effective amount of about 0.5 to 5% based on anhydrous material; and

a mixture of N-alkyl and/or N-cycloalkyl pyrrolidones such as N-methylpyrrolidone and N-cyclohexylpyrrolidone, the volume ratio of each pyrrolidone being about 10:1 to 1:10, preferably 5:1 to 1:5.

The method of removing the silicone polymer adhesive or other cured resin deposit from a substrate using the above stripping compositions comprises contacting the substrate with the composition preferably at a temperature of about 25° C. up to about 110°-120° C. or higher for an effective time of usually about 30 min. to 2 hours or more, e.g., 8 hours. The immersion time for degrading, dissolving, removing or stripping the silicone polymer adhesive is typically dependent on the exposure of the deposit to the stripping composition and on the temperature of the stripping composition whereas at higher temperatures a lower contact time is generally needed for removal of the silicone adhesive polymer.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows a typical single chip module having a ceramic chip carrier or substrate with a single chip attached through solder joints encapsulated with epoxy encapsulant, a thermal compound dispensed over the chip for cooling, and a metal cap for device protection which is bonded to the substrate through a silicone polymer adhesive seal band at the perimeter.

FIG. 2 shows a single chip module assembly as in FIG. 1 but having a heat sink or heat slug attached to the protective cap with a thermally conductive silicone adhesive.

FIG. 3 shows a conventional single chip module as in FIG. 1 with a metal plate bonded to the chip with a silicone polymer adhesive.

FIG. 4 shows a single chip module as in FIG. 3 where a thermally conductive silicone adhesive is used to attach a metal heat sink to the metal plate and the metal plate to the chip.

FIG. 5 illustrates a multi-chip module (MCM) with a conventional protective cap attached to the chip carrier with a silicone polymer adhesive.

FIG. 6 is an illustration of an MCM having a metal heat sink attached to the protective cap with a thermally conductive silicone adhesive conductive filler.

FIG. 7 is an illustration of a multi-chip module where a metal plate for heat dissipation is directly attached to the back side of the chip with a silicone polymer adhesive

FIG. 8 shows the multi-chip module of FIG. 7 wherein a metal heat sink is attached to the metal plate with a thermally conductive silicone adhesive.

### DESCRIPTION OF THE PREFERRED EMBODIMENT(S)

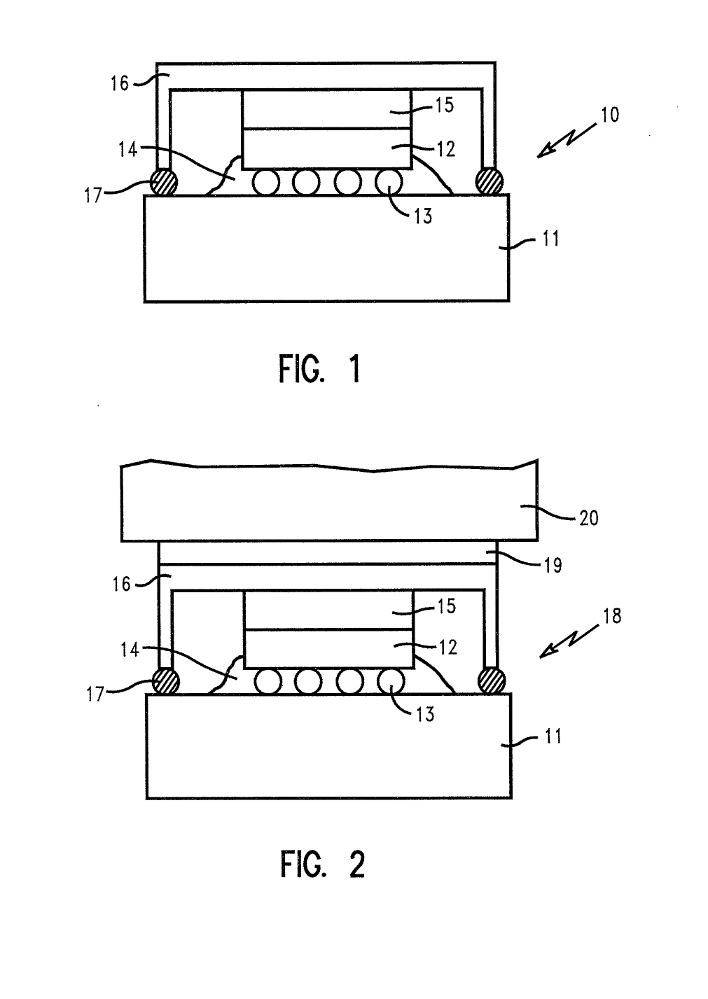

In describing the preferred embodiment of the present invention, reference will be made herein to FIGS. 1-8 of the drawings in which like numerals refer to like features of the invention. Features of the invention are not necessarily shown to scale in the drawings.

The present invention is generally concerned with an improved method of removing cured resins such as elastomeric silicone adhesive deposits from ceramic and metal surfaces of electronic modules to provide reworkability options in assembly processes including diagnostic tests, parts replacement and recovery of substrates from test vehicles. Of particular concern is the removal of cured Sylgard™ residue from seal band and other surfaces requiring removal of silicone adhesive for reworkability in non-hermetic electronic packages where it is used to attach a metal cap to substrate for protection against mechanical damage, moisture ingress and corrosion from exposure to the environment or to attach other components in module assembly process. The method disclosed provides reworkability of module assembly for diagnostic tests, parts replacement and recovery of substrates, and reclamation of expensive test vehicles.

Stripping compositions used to treat the electronic module to dissolve, remove, strip or otherwise attack and degrade the silicone polymer according to this invention comprise a base, preferably an aliphatic quaternary ammonium hydroxide, a surfactant preferably a non-ionic surfactant including alkyl aryl polyether, fluoroalky polyethers, polyalkyl glycosides or alkyl ethoxylated alcohol which surfactants are known to be biodegradable and the balance a high boiling non-hazardous solvent such as di- or tri-propylene glycol alkyl ether. Ionic surfactants and/or amphotenic surfactants can also be used in conjunction with nonionic surfactants.

Another stripping composition of the invention comprises a base, preferably an aliphatic quaternary ammonium hydroxide and at least two (2) pyrrolidone materials such as N-methylpyrrolidone (NMP) and N-cyclohexylpyrrolidone (CHP), with or without a surfactant.

As exemplary, it has been found according to this invention that cured elastomeric silicone adhesive residues can be readily removed from electronic component ceramic and metal surfaces by exposing the adhesive residue surfaces preferably at an elevated temperature to a solution comprising about 0.05 to 0.5% by weight of a non-ionic surfactant of the type alkyl aryl polyether or alkyl alcohol ethoxylate, and an effective amount about 0.5-5% by weight of tetraalkyl ammonium hydroxide based on anhydrous material and a high boiling, preferably di- and/or tri-propylene glycol alkyl ether and related materials such as Dowanol Glycol Ether solvents sold by Dow Chemical Co. The stripping composition is used to contact an adhesive polymer and cause disintegration of the polymer matrix and substantial removal of the polymer from the substrate. The contacted parts are then preferably thoroughly rinsed with deionized water by pressurized spray or other means of agitation to remove any residual residue and to wash the stripping solution off the surface of the substrate. Alternately, the contacted parts can be rinsed with a low boiling solvent such as acetone or 2-propanol (IPA). However, water rinsing is preferred according to this invention due to the hazards associated with volatile solvents.

Various solvents that are suitable for use in the stripping compositions to remove cured silicone polymer deposits according to this invention are compatible with the base and have a high flash point (fp) preferably above about 65° C., low vapor pressure, partial or complete solubility in water, are non-hazardous with no significant environmental regulatory issues, non-toxic and are commercially available at low cost. Representative candidates in this category for one stripping composition embodiment of this invention include: propylene glycol alkylethers, particularly di(propylene glycol) methyl ether (fp. 75° C.), di(propylene glycol) butyl ether (fp 96° C.), tri(propylene glycol) monomethyl ether (fp.>109° C.) and tri(propylene glycol) monobutyl ether (fp>109° C.), and tri(propylene glycol) n-propyl ethers. The alkyl group is about C1-C8, preferably C1-C4.

Solvents for stripping compositions in the second embodiment include: N-methylpyrrolidone (NMP), N-ethylpyrrolidone (NEP), and N-cyclohexylpyrrolidone (CHP) and other suitable compatible N-alkyl pyrrolidones. A mixture of N-alkylpyrrolidones is preferred and is preferably NMP and CHP because of its demonstrated effectiveness. The amount of each pyrrolidone may vary and the volume ratio of one pyrrolidone to the other pyrrolidone is broadly about 1:10 to 10:1, preferably 5:1 to 1:5.

Any suitable organic base may be used but is preferably an aliphatic quaternary ammonium hydroxide preferably tetramethyl ammonium hydroxide. The tetramethyl or other ammonium hydroxide (TMAH) may be any suitable concentration by weight of the composition and is generally about 0.5 to 5% or more, preferably about 1 to 3% and most preferably about 1 to 2% based on the anhydrous material although hydrates such as TMAH pentahydrate is generally used taking into account the effective concentration of the TMAH active ingredient. Other bases include tetraethyl ammonium hydroxide (TEAH), tetrabutyl ammonium hydroxide (TBAH) and 2-hydroxyethyl trimethyl ammonium hydroxide (Choline hydroxide) benzyl trialkyl ammonium hydroxide and related systems.

The surfactant is present in an amount, by weight %, about 0.05% to 5%, preferably 0.1% to 2%, and most preferably 0.1% to 0.5%.

The quaternary ammonium bases used in accordance with the present invention are preferably aliphatic quaternary ammonium hydroxides, in particular tetraalkyl ammonium hydroxides represented by the formula:

R₁R₂R₃R₄NOH

where R₁R₂R₃ and R₄ are the same or different and are selected from the group consisting of an organic radical CₙH₂ₙ₊₁, with n=1-4. Another quaternary ammonium hydroxide is wherein R₁R₂ and R₃ are alkyl groups, preferably the same methyl group, and R₄ is a substituted alkyl group, e.g., a hydroxyalkyl group, benzyl group and related systems. Among these, the compounds containing alkyl groups having 1 to 8, particularly 1 to 4 carbon atoms are preferred. One or more of such alkyl groups can be substituted by functionalized alkyl groups or a benzyl group, e.g., hydroxy ethyl (CH₂CH₂OH) as in trimethyl hydroxyethyl ammonium hydroxide or a benzyl group as in trimethyl benzyl ammonium hydroxide. It is also possible for some of the alkyl groups to be replaced by alkenyl groups. The preferred organic quaternary ammonium hydroxides are the tetraalkyl ammonium hydroxides having alkyl groups of 1 to 4 carbon atoms with the preferred base being tetramethyl ammonium hydroxide (TMAH).

Representative tetraalkyl ammonium hydroxide organic bases to be used in the stripping compositions according to this invention are tetramethyl ammonium hydroxide (TMAH) available as the pentahydrate [(CH₃)₄N⁺OH⁻.5H₂O], tetraethyl ammonium hydroxide (TEAH) Et₄N⁺OH⁻; tetrabutyl ammonium hydroxide (TBAH) Bu₄N⁺OH⁻; and trimethyl-2-hydroxyethyl ammonium hydroxide (Choline hydroxide, a natural product), benzyl trimethyl ammonium hydroxide (CH₃)₃•CH₂C₆H₅N⁺OH⁻.

Representative surfactants suitable for the compositions are preferably of the non-ionic category typically, alkyl aryl polyethers such as Triton X-100 and Triton CF-10 (octylphenoxy polyoxyethanol based) and related systems, polyethoxylated alcohols as dodecyl alcohol ethoxylate, and fluoroalkyl polyoxyethanol type, for example DF-1, and polyalkyl glycosides such as the Glucopon series available from Henkel-Emery Corp. Other suitable non-ionic and other commonly known surfactants such as anionic and amphoteric surfactants may be employed and combinations thereof, such as a non-ionic and amphoteric mixture.

The parts are treated with the tetraalkyl ammonium hydroxide containing stripping solution at room temperature up to about 110°-120° C. or more for up to about 2 hours to 8 hours or more typically for about 60 to 90 minutes. After treating the electronic module with the tetraalkyl ammonium hydroxide containing stripping solution, the component or part is immediately (preferably within less than 15 minutes, more preferably within less than 5 minutes) rinsed preferably by spray rinse with deionized water, and preferably dried with an inert gas such as nitrogen.

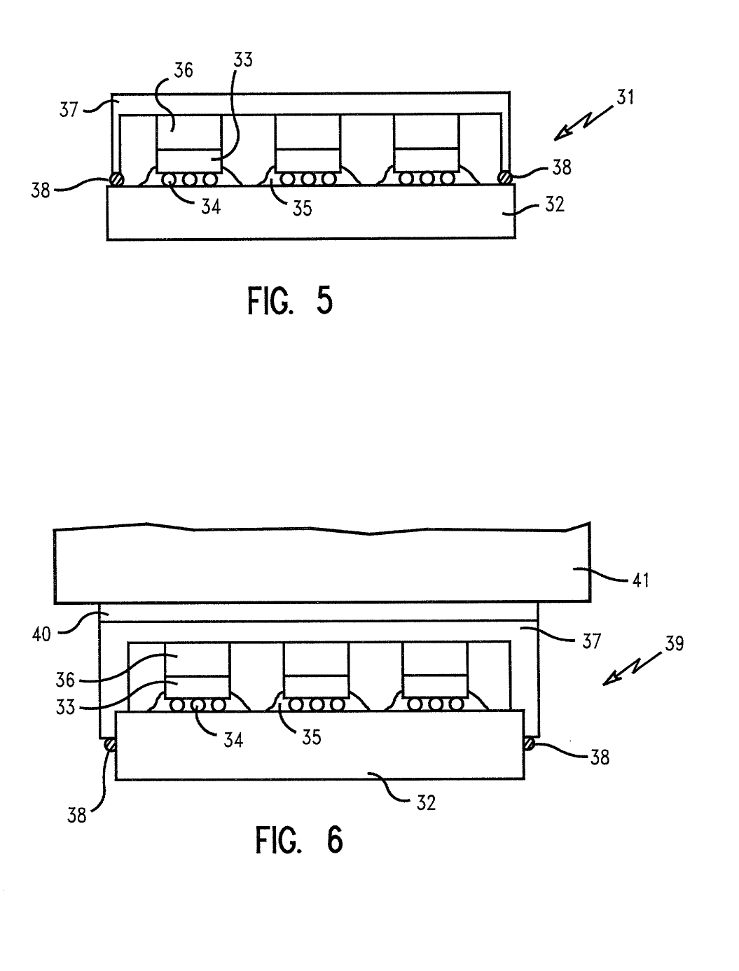

One stripping composition for removing silicone polymer residue according to this invention is prepared by mixing 2-5 wt % of tetramethyl ammonium hydroxide pentahydrate (TMAH.5H₂O) and 0.20 wt % of a non-ionic surfactant octyl phenoxy polyoxyethanol as Triton CF-10 in di(propylene glycol) methyl ether to provide an effective TMAH as active ingredient, concentration of about 1-2.5%, and about 0.1-0.15 wt % effective concentration of the surfactant depending on the active ingredient. The mixture is heated with gentle agitation to 70-100° C., preferably to 75-95° C. to form a clear solution. In the case of a bonded protective cap as in a single chip module (SCM) and multichip module (MCM) shown in FIGS. 1 and 5, it is preferred that the cap be first mechanically separated to expose the adhering silicone material on the ceramic surface and on the cap seal ring. The two parts are then immersed in the heated stripping solution for 45-90 min. with constant agitation which causes disintegration and flaking off of the polymer. This step is immediately followed by deionized water rinse under pressurized spray to remove all residue and to wash-off stripping solution from the surfaces and any still adhering residue is wiped off and rinsed with water followed by drying. Alternate compositions using related propylene glycol solvents, bases including quaternary ammonium bases, and the non-ionic surfactants described above can be prepared and used according to the same process.

In another representative example, a solution containing dipropylene glycol monomethyl ether (DPM), about 2 wt % of tetramethyl ammonium hydroxide (TMAH) based on (CH3)4NOH and about 0.15 wt % of octylphenoxy polyoxyethanol Triton CF10 surfactant was used for removing cured Sylgard™ residue from a ceramic substrate and from an aluminum cap as described below.

The other silicone polymer stripping composition of the invention comprises a mixture of pyrrolidones, preferably a mixture of alkyl and cycloalkyl pyrrolidones such as NMP and CHP as the solvent system and a base such as a quaternary ammonium hydroxide with or without a non-ionic surfactant as an additive as described for the propylene glycol alkyl ether solvent system. A representative stripping composition is prepared by mixing 2.5-5 wt % of TMAH.5H₂O in a 5:1 (vol/vol) mixture of N-methyl pyrrolidone and N-cyclohexyl pyrrolidone, respectively, and the mixture heated to 80-95° C. with gentle agitation such as stirring. The parts carrying exposed silicone adhesive are immersed in the heated solution with constant agitation and removal of the polymer is monitored as a function of time. It was found that the polymer substantially disintegrates in 60-90 min. which is mostly removed in the mechanically agitated stripping solution while any remaining residue comes off in a subsequent deionized water rinse cycle. With bonded parts where the silicone adhesive is not directly exposed to the solution, it takes longer to separate the parts and remove the residue from the initially bonded surfaces. Addition of a surfactant provides slight improvement in the stripping efficiency of the N-alkyl-2-pyrrolidone based stripping composition.

A metal protective cap attached through a seal band to the ceramic substrate of a single chip electronic module (SCM) using Sylgard as an adhesive was first mechanically separated from the substrate to expose the adhesive band on the metal cap and on the substrate. The separated parts were immersed in a gently agitated solution containing 200 ml of dipropylene glycol mono methyl ether (DPM), 4.2 g tetramethyl ammonium hydroxide pentahydrate (TMAH.5H₂O) which is about 2.1 g effective amount based on anhydrous TMAH, and 0.3 g octyl phenoxy polyoxyethanol, e.g., Triton CF10 (Trade name of BASF) at 80-90° C. for 45-60 min. which caused disintegration and partial removal of the silicone adhesive from the surface. The parts were then removed and immediately rinsed with deionized water, preferably by pressure spray to facilitate the removal of the residual degraded adhering material and the removal of the contacting stripping solution from the surface followed by drying by forced air or nitrogen gas to give clean residue-free surfaces.

An alternate solvent formulation comprising 5 volume parts N-methyl pyrrolidone (NMP), 1 volume part N-cyclohexylpyrrolidone (CHP), and 2.5% by weight TMAH•5H₂O used at 80-95° C. for 1 hr. followed by deionized water pressurized spray rinse was also found effective in stripping the Sylgard deposits. In this case, addition of a surfactant in the stripping solution was slightly beneficial in terms of removal efficiency.

The method disclosed according to this invention for removing cured silicone polymer can be used for rework processes requiring removal of a protective cap or lid, metal heat sink or metal plate attached to the substrate using insulative or conductive silicone adhesive. The new method of silicone adhesive removal to provide residue-free surfaces can be applied to both the single chip (SCM) or multi-chip module (MCM) assemblies. FIGS. 1-8 illustrate the various module assemblies where Sylgard adhesive is typically utilized.

Referring now to the figures, FIG. 1 shows a typical single chip module 10 having a ceramic chip carrier or substrate 11 with a single chip 12 attached through solder joints 13. An epoxy encapsulant 14 is typically used to encapsulate the solder joints and a thermal compound 15 dispensed on the surface of the chip for cooling. A metal cap 16 contacts the thermal compound 15 and is used for device protection and is bonded to the substrate 11 through a silicone polymer seal band 17. FIG. 2 shows the single chip module assembly as in FIG. 1 but additionally shows a heat sink or heat slug 20 attached to the protective cap 16 by a thermally conductive silicone adhesive 19.

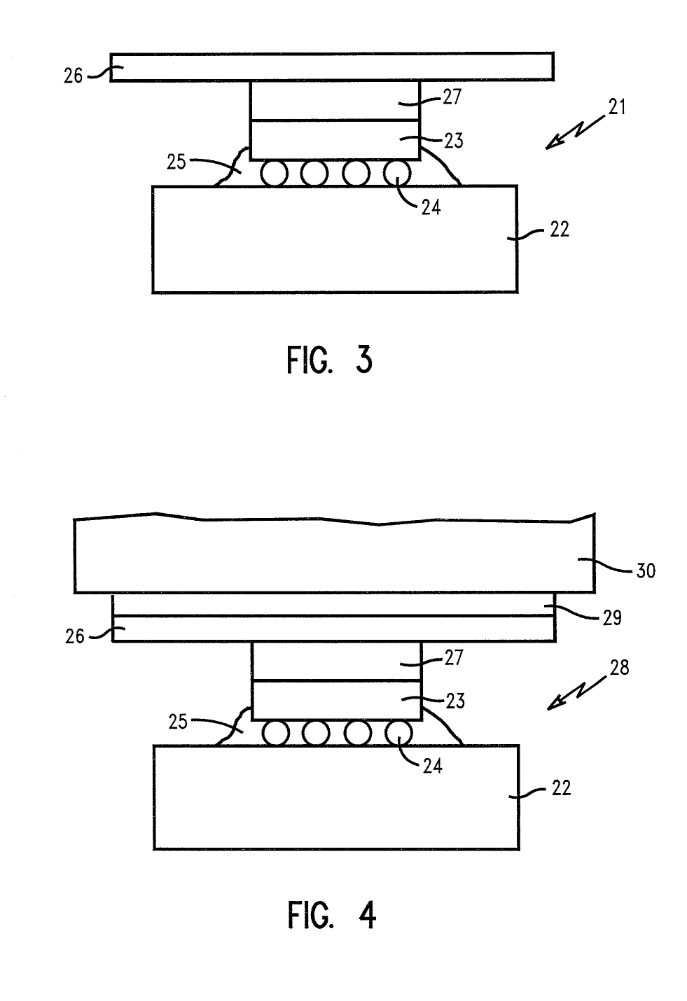

FIG. 3 shows a conventional single chip module assembly as in FIG. 1 generally as 21. Thus, a ceramic chip carrier or substrate 22 with a single chip 23 attached to solder joints 24 is shown with the solder joints being encapsulated with an epoxy encapsulant 25. A metal plate 26 is bonded to the chip 23 with a silicone polymeric adhesive 27. FIG. 4 shows a single chip module assembly as in FIG. 3 generally as 28. The metal plate 26 of the chip assembly is shown attached to a metal heat sink 30 by a thermally conductive silicone polymer adhesive 29.

FIG. 5 illustrates a multi-chip module (MCM) generally as 31 wherein a ceramic chip carrier or substrate 32 is connected to a plurality of chips 33 through solder bonds 34. An epoxy encapsulant 35 encapsulates the solder bonds. A thermal paste 36 is shown on the surface of chips 33 which is used for removal of heat from the chip. A protective cap 37 is shown attached to chip carrier 32 with a silicone adhesive polymer 38. FIG. 6 is an illustration of the MCM of FIG. 5 shown generally as 39 having a metal heat sink 41 attached to the protective cap 37 with a thermally conductive silicone adhesive 40 carrying thermally conductive filler.

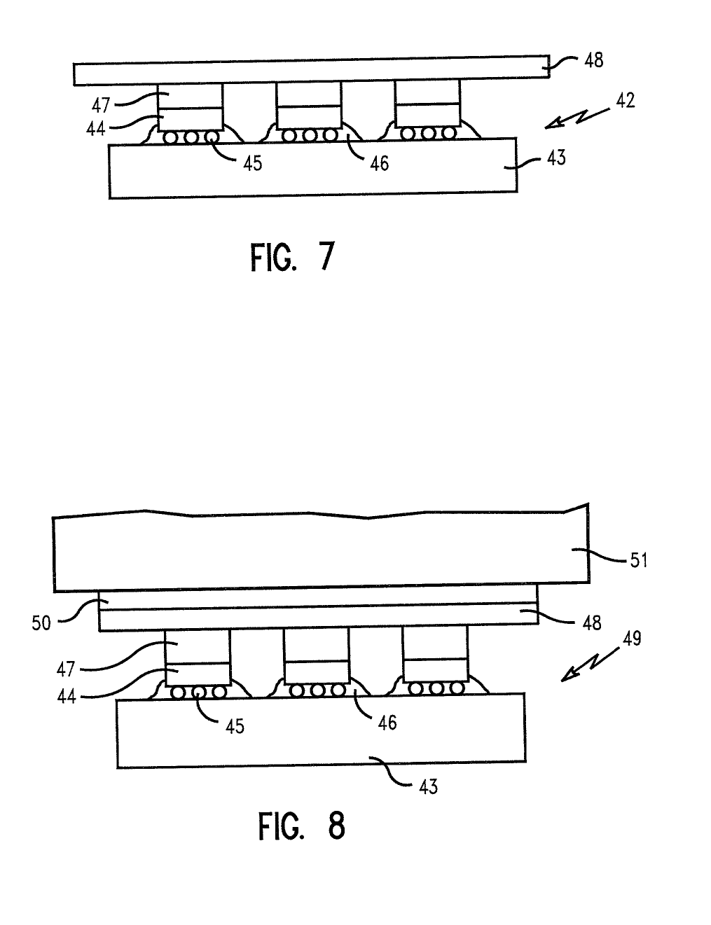

FIG. 7 is a representation of a multi-chip module shown generally as 42 having a ceramic chip carrier 42 attached to a plurality of chips 44 through solder joints 45. An epoxy encapsulant 46 encapsulates the solder joints. A silicone polymer adhesive 47 is used to attach the chips 44 to a metal plate 48 which is typically used for heat dissipation. FIG. 8 shows the MCM of FIG. 7 generally as 49 and further includes a metal heat sink 51 attached to metal plate 48 by a thermally conductive silicone adhesive 50.

The above electronic components modules are typical modules used in industry. All the modules use a silicone polymer adhesive to connect various parts of the electronic module and it is these silicone adhesives which are removed by the method and stripping composition of the invention to provide for rework of the module or to carry out diagnostic tests or to replace or repair the semiconductor device or to recover electrically good substrates from test vehicles. It will be appreciated by those skilled in the art, other type electronic components using a silicone polymer adhesive may suitably be treated using the method and stripping compositions of the invention.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method for removing cured resin deposits from ceramic and metal surfaces of electronic modules comprising the steps of:
supplying a ceramic or metal electronic module having a cured resin residue deposit on the module surface;
contacting the module with a stripping composition comprising a base, a surfactant and a compatible non-hazardous high boiling organic solvent having a flash point over about 60° C., the contacting being performed for an effective time to strip and degrade the silicone polymer adhesive deposit on the substrate surface; and
rinsing the contacted module to remove the residual degraded contacted resin and stripping composition.

2. The method of claim 1 wherein the cured resin is an elastomeric silicone adhesive.

3. The method of claim 2 wherein the base is a quaternary ammonium hydroxide.

4. The method of claim 1 wherein the solvent is a di- or tri-propylene glycol alkyl ether wherein the alkyl group is a CₙH₂ₙ₊₁ wherein n is an integer of 1-4.

5. The method of claim 1 wherein the surfactant is a non-ionic surfactant.

6. The method of claim 1 wherein the surfactant is ionic, amphoteric or a mixture thereof.

7. The method of claim 6 wherein the surfactant is a combination of a non-ionic and amphoteric surfactant.

8. A method for removing cured resin deposits from ceramic and metal surfaces of electronic modules comprising the steps of:
supplying a ceramic or metal electronic module having silicone polymer adhesive deposits on the module surface;
contacting the electronic module with a stripping composition comprising a base, and a mixture of N-alkyl pyrrolidone components, the contacting being performed for an effective time to strip and degrade the cured resin deposit on the electronic module surface; and
rinsing the contacted substrate with water to remove the residual degraded contacted resin and stripping composition.

9. The method of claim 8 wherein the cured resin is a cured elastomeric silicone adhesive.

10. The method of claim 8 wherein the base is a quaternary ammonium hydroxide.

11. The method of claim 8 wherein the solvent is a mixture of N-methylpyrrolidone and N-cyclohexylpyrrolidone.

12. A stripping composition for removing cured resin deposits from ceramic and metal surfaces of electronic modules comprising, by weight %:
a base in an amount of about 0.5 to 5;
a surfactant in an amount of about 0.05 to 0.5 and
a compatible high boiling solvent, having a flash point above about 60° C., and which is environmentally and chemically safe.

13. The stripping composition of claim 12 wherein the base is a quaternary ammonium hydroxide.

14. The stripping composition of claim 12 wherein the surfactant is a non-ionic surfactant.

15. The stripping composition of claim 12 wherein the solvent is di or tri propylene glycol alkyl ether wherein the alkyl group is C1-C4.

16. The stripping composition of claim 13 wherein the quaternary ammonium hydroxide is tetramethyl ammonium hydroxide.

17. A stripping composition for removing cured resin deposits from ceramic and metal surfaces of electronic modules comprising, by weight %:
a base in an amount of about 0.5 to 5; and
a mixture of N-alkyl pyrrolidone components the volume ratio of each pyrrolidone component being about 1:10 to 10:1.

18. The stripping composition of claim 17 wherein the base is a quaternary ammonium hydroxide.

19. The stripping composition of claim 18 wherein the mixture of N-alkyl pyrrolidone components is N-methylpyrrolidone and N-cyclohexylpyrrolidone.

20. An electronic component stripped of a cured polymer adhesive using the method of claim 1.

21. An electronic component stripped of a cured polymer adhesive using the method of claim 8.
